(19) United States
(12) Patent Application Publication
(10) Pub. No.: US 2022/0088637 A1
(43) Pub. Date: Mar. 24, 2022

(54) COMPACT ULTRASOUND DEVICE HAVING ANNULAR ULTRASOUND ARRAY PERIPHERALLY ELECTRICALLY CONNECTED TO FLEXIBLE PRINTED CIRCUIT BOARD AND METHOD OF ASSEMBLY THEREOF

(71) Applicant: Ulthera, Inc., Mesa, AZ (US)

(72) Inventors: Jeremy A. Brown, Halifax (CA); Jeffrey R. Leadbetter, Dartmouth (CA); Charles D. Emery, Gilbert, AZ (US)

(21) Appl. No.: 17/542,962

(22) Filed: Dec. 6, 2021

Related U.S. Application Data
(63) Continuation of application No. 16/069,319, filed on Jul. 11, 2018, now Pat. No. 11,224,895.
(60) Provisional application No. 62/280,038, filed on Jan. 18, 2016.

(51) Int. Cl. B06B 1/06

(52) U.S. Cl. CPC B06B 1/0625

(57) ABSTRACT

Ultrasound devices, and associated methods of assembly thereof, are disclosed whereby an annular electrode array of an ultrasound transducer is electrically connectedto a flexible printed circuit board in a compact configuration. The flexible circuit board includes an elongate flexible segment and a distal distribution segment, where the distribution segment is attached to a peripheral support ring that surrounds at least a portion of the ultrasound transducer. The distribution segment includes a plurality of spatially distributed contact pads, and electrical connections are provided between the contact pads and the annular electrodes of the annular array. A backing material may be provided that contacts and extends from the annular array electrodes, and a distal portion of the elongate flexible segment may be encapsulated in the backing material, such that the distal portion extends inwardly from the peripheral support ring, without contacting the electrical connections and without contacting the array surface.

### INCORPORATION BY REFERENCE TO ANY PRIORITY APPLICATIONS

This application is a continuation of U.S. application Ser. No. 16/069,319 filed on Jul. 11, 2018, which is a U.S. National Phase application of Intl. App. No. PCT/US2017/013657 filed on Jan. 16, 2017 and published in English as WO 2017/127328 on Jul. 27, 2017, which claims the benefit of priority from U.S. Provisional Patent Application No. 62/280,038 filed on Jan. 18, 2016, which is incorporated in its entirety by reference, herein. Any and all applications for which a foreign or domestic priority claim is identified in the Application Data Sheet as filed with the present application are hereby incorporated by reference under 37 CFR 1.57.

### BACKGROUND

Several embodiments of the present invention disclosure relate to the assembly and electrical interconnection of ultrasound transducers having annular arrays.

### SUMMARY

Embodiments (e.g., examples) of ultrasound devices, and associated methods of assembly thereof, are disclosed whereby an annular electrode array of an ultrasound transducer is electrically connected (e.g., wire bonded or conductive epoxied, etc.) to a flexible printed circuit board in a compact configuration. The flexible circuit board includes an elongate flexible segment and a distal distribution segment, where the distribution segment is attached to a peripheral support ring that surrounds at least a portion of the ultrasound transducer. The distribution segment includes a plurality of spatially distributed contact pads, and electrical connectors (e.g., wire bonds or conductive epoxy) are provided between the contact pads and the annular electrodes of the annular array. A backing material may be provided that contacts and extends from the annular array electrodes, and a distal portion of the elongate flexible segment may be encapsulated in the backing material, such that the distal portion extends inwardly from the peripheral support ring, without contacting the electrical connectors (e.g., wire bonds or conductive epoxy) and without contacting the array surface.

Accordingly, in one embodied aspect, there is provided an ultrasound device comprising: an ultrasound transducer comprising an annular ultrasound array, wherein said annular ultrasound array is defined at least in part by a plurality of concentric annular electrodes provided on a first surface of a piezoelectric layer, and wherein a ground plane electrode is provided on a second surface of said piezoelectric layer; a peripheral support ring surrounding at least a portion of said ultrasound transducer; and a flexible printed circuit board comprising: an elongate flexible segment; and a distribution segment that is in contact with at least a portion of said peripheral support ring, such that a plurality of conductive paths extending through said elongate flexible segment are routed through said distribution segment to respective contact pads located at different locations on said peripheral support ring; wherein each annular electrode is electrically connected (e.g., wire bonded or conductive epoxied) to a respective contact pad; and wherein at least one conductive path of said flexible printed circuit board is a ground conductive path that is in electrical contact with said ground plane electrode.

In various embodiments, an ultrasound device includes an ultrasound transducer comprising an annular ultrasound array, wherein the annular ultrasound array is defined at least in part by a plurality of concentric annular electrodes provided on a first surface of a piezoelectric layer, and wherein a ground plane electrode is provided on a second surface of the piezoelectric layer, a peripheral support ring surrounding at least a portion of the ultrasound transducer; and a flexible printed circuit board. In an embodiment, the flexible printed circuit board includes an elongate flexible segment and a distribution segment that is in contact with at least a portion of the peripheral support ring, such that a plurality of conductive paths extending through the elongate flexible segment are routed through the distribution segment to respective contact pads located at different locations on the peripheral support ring. In an embodiment, each annular electrode is electrically connected (e.g., wire bonded and/or conductively epoxied) to a respective contact pad. In an embodiment, at least one conductive path of the flexible printed circuit board is a ground conductive path that is in electrical contact with the ground plane electrode.

In an embodiment, the device also includes a backing material contacting and extending from the first surface, wherein a distal portion of the elongate flexible segment is encapsulated in the backing material, such that the distal portion of the elongate flexible segment extends inwardly (e.g., parallel and along the first surface) from the peripheral support ring and bends outwardly (e.g., perpendicularly) away from the first surface, within the backing material, without contacting the wire bonds and without contacting the first surface. In an embodiment, the plurality of conductive paths are routed bi-directionally within the distribution segment. In an embodiment, the distal portion of the elongate flexible segment comprises a plurality of branched distal segments that contact the peripheral support ring at different locations with gaps defined there between. In an embodiment, one or more of the branched distal segments include only two conductive paths. In an embodiment, the two conductive paths are bi-directionally routed to different contact pads. In an embodiment, one or more wire bonds are formed within each gap. In an embodiment, the distal portion of the elongate flexible segment is bent, within the backing material, over an angle ranging between 90 degrees and 180 degrees relative to the first surface. In an embodiment, the elongate flexible segment is encapsulated within the backing material and emerges from a distal surface of the backing material without extending beyond a side surface of the backing material. In an embodiment, the elongate flexible segment emerges from the backing material at an angle of approximately 90 degrees relative to the first surface. In an embodiment, the elongate flexible segment emerges from the backing material at an angle of greater than or equal to approximately 90 degrees relative to the first surface. In an embodiment, an initial radius of curvature of the distal portion of the elongate flexible segment is less than 8 mm. In an embodiment, a contact surface of the peripheral support ring that contacts the distribution segment is spatially offset from the first surface. In an embodiment, the elongate flexible segment extends outwardly from the peripheral support ring. In an embodiment, the peripheral support ring has a transverse width of less than 1 mm. In an embodiment, the peripheral support ring completely surrounds the ultrasound transducer. In an embodiment, the ultrasound transducer is disc shaped, and wherein the peripheral support ring is at least a portion of an annulus. In an embodiment, an outer diameter of the annulus is less than 10 mm. In an embodiment, the peripheral support ring is electrically conductive, and wherein the peripheral support ring is in electrical communication with the ground conductive path and the ground plane electrode. In an embodiment, the plurality of concentric annular electrodes are provided in a sparse configuration, thereby defining a sparse annular ultrasound array.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 shows an example of an ultrasound transducer having an annular ultrasound array.

FIGS. 2A and 2B show (A) a peripheral support ring surrounding an ultrasound transducer having an annular ultrasound array, and (B) a flexible printed circuit board suitable for mounting to the peripheral support ring and electrically connecting (e.g., wire bonding or conductive epoxying) to the annular electrodes of the annular ultrasound array.

FIGS. 3A and 3B show front and back views, respectively, of an assembly in which an ultrasound transducer is surrounded by a peripheral support ring having a flexible printed circuit board mounted thereto, prior to electrically connecting (e.g., wire bonding or conductive epoxying).

FIGS. 4A and 4B show top and sides views, respectively, of an assembly in which an ultrasound transducer is surrounded by a peripheral supporting ring having a flexible printed circuit board mounted thereto, after electrically connecting (e.g., wire bonding or conductive epoxying).

FIGS. 5A and 5B show top and sides views, respectively, of an assembly in which an ultrasound transducer is surrounded by a peripheral supporting ring having a flexible printed circuit board mounted thereto, after incorporation of a backing material.

FIG. 6 shows the addition of a ground plane electrode and a matching layer.

FIGS. 7A and 7B show an example embodiment in which the distal portion of the elongate segment of a flexible printed circuit board extends inwardly from the peripheral ring for encapsulation within a backing material.

FIGS. 8A and 8B show top and side views of the embodiment shown in FIGS. 7A and 7B.

FIG. 9 shows an example embodiment of a flexible printed circuit board having branched distal segments, with two conductive signal paths per branched distal segment.

FIG. 10 shows another example embodiment of a flexible printed circuit board having branched distal segments, with sixteen conductive signal paths, and four conductive signal paths per branched distal segment.

FIG. 11 shows an example assembly jig for mounting the distribution segment of the printed circuit board to the peripheral support ring.

FIGS. 12A-12E show photographs of several assembly steps of an example method, including steps involving the addition of a backing material.

FIGS. 13 and 14A-C show illustrations of several example assembly steps including the addition of a backing material.

FIG. 15 shows eight assembly jigs as individually depicted in FIG. 11, each containing a peripheral support ring having a flexible printed circuit board mounted thereto for the purpose of reflow soldering.

FIGS. 16A and 16B illustrate an example embodiment in which each annular array includes conductive features that encode information.

### DETAILED DESCRIPTION OF THE PREFERRED EMBODIMENT

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 10 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

In various example embodiments of the present disclosure, ultrasound devices are described in which electrodes of an annular ultrasound array are electrically connected (e.g., wire bonded or conductive epoxied) to a flexible printed circuit board. Various configurations and methods of manufacture are provided for forming electrical connections (e.g., wire bonds or conductive epoxy) between annular electrodes of the annular ultrasound array and contact pads of the flexible printed circuit board, where the contact pads are supported by, and spatially distributed around, a peripheral support ring that surrounds at least a portion of the ultrasound transducer.

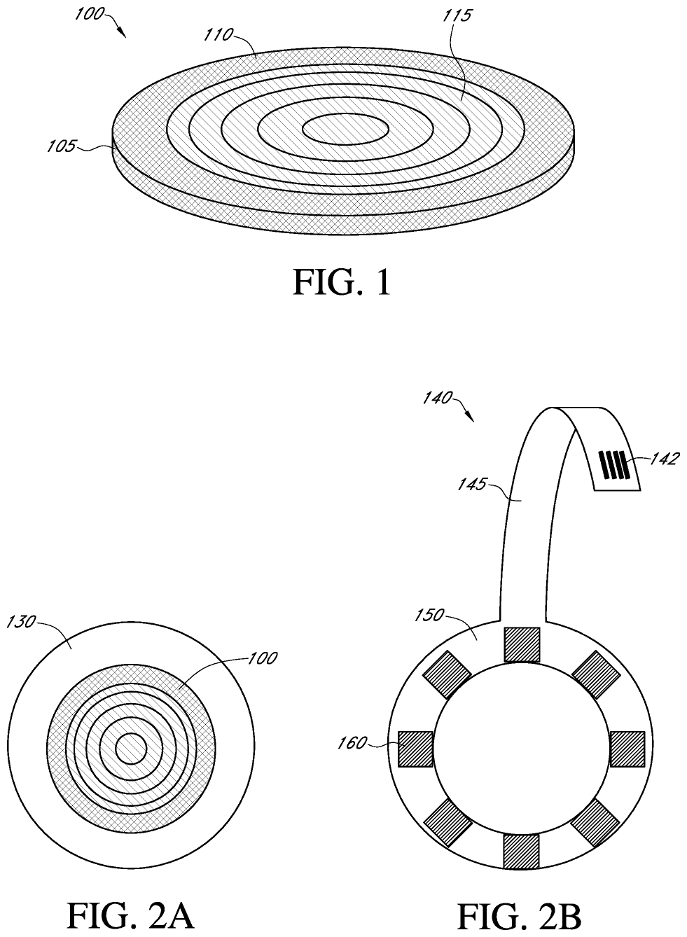

FIG. 1 shows an example of an ultrasound transducer 100 that includes an annular ultrasound array. The example ultrasound transducer 100 includes a piezoelectric layer 105 having a first side 110 on which a set of concentric annular electrodes 115 are provided. The other surface (not shown) of the piezoelectric layer 105 has an electrode provided thereon (e.g. a ground plane electrode). The concentric annular electrodes 115 define, at least in part, annular array elements of the annular ultrasound array. The array may be a kerfed array, or may be a kerfless array. The ultrasound transducer 100 may include one or more additional layers, such as impedance matching layers, and a backing material (e.g., an acoustic backing material).

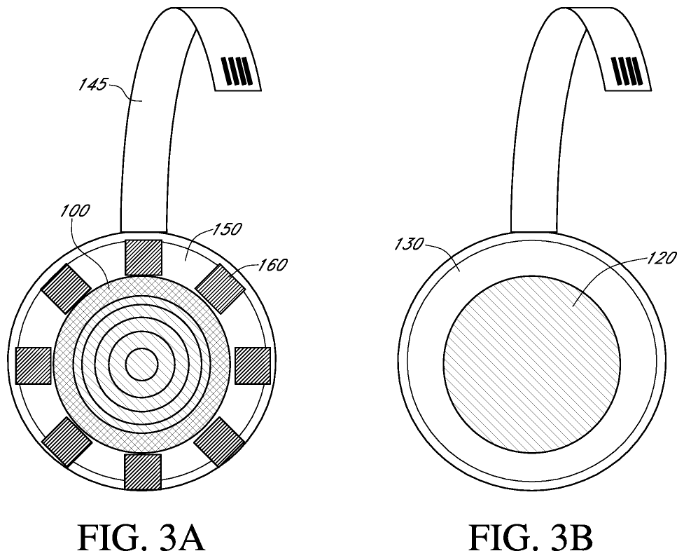

As shown in FIGS. 2A, 2B, 3A and 3B, the electrically connecting (e.g., wire bonding or conductive epoxying) of the annular electrodes 115 to contact pads of a flexible printed circuit board may be facilitated by the use of a peripheral support ring. As shown FIG. 3A, a peripheral support ring 130 is provided such that it surrounds at least a portion of the ultrasound transducer 100. The peripheral support ring 130 is shaped to support the distal region of a flexible printed circuit board. The peripheral support ring 130 may be electrically conductive over its entirety or over a portion thereof.

An example of a suitable flexible printed circuit board 140 is shown in FIG. 2B. The example flexible printed circuit board 140 has an elongate flexible segment 145 and a distribution segment 150 (which may also be flexible). The distribution segment 150 has a spatially distributed array of contact pads 160 that are in electrical communication with the conductive paths of the flexible printed circuit board. The proximal region of the elongate flexible segment 145 may include a plurality of proximal contact pads.

The distribution segment 150 is shaped so that it can be mounted or otherwise affixed to the peripheral support ring 130. FIGS. 3A and 3B show a configuration in which the distribution segment 150 is mounted to the peripheral support ring (the peripheral support ring lies beneath the distribution segment 150 in FIG. 3A). The contact pads 160 of the distribution segment 150 are spatially distributed around the outer perimeter of the ultrasound transducer 100, thus facilitating electrically connecting (e.g., wire bonding or conductive epoxying).

FIG. 3B shows the corresponding back view relative to FIG. 3A, where the ground plane electrode 120 is visible adjacent to the peripheral support ring 130. This second surface, shown in FIG. 3B, is the surface through which the ultrasound beam is to be emitted and/or received.

As described below, in some embodiments, the peripheral support ring 130 may be electrically conductive and brought into electrical communication with a ground conductive path of the flexible printed circuit and with the ground plane electrode 120 of the ultrasound transducer. For example, the bottom surface of the distribution segment 150 may include an exposed conductive region that may be attached to a conductive peripheral support ring though an electrically conductive bonding means (such as soldering), and the electrical connection between the bottom surface of the conductive peripheral support ring and the ground plane electrode 120 of the ultrasound transducer may be may via evaporative deposition of a metal (this evaporative step may be performed after infiltration with an epoxy backing material, as described in further detail below, such that a gap between the ultrasound transducer and the peripheral support ring is filled, at least partially, with backing material, upon which the metal may be deposited to form the electrical connection).

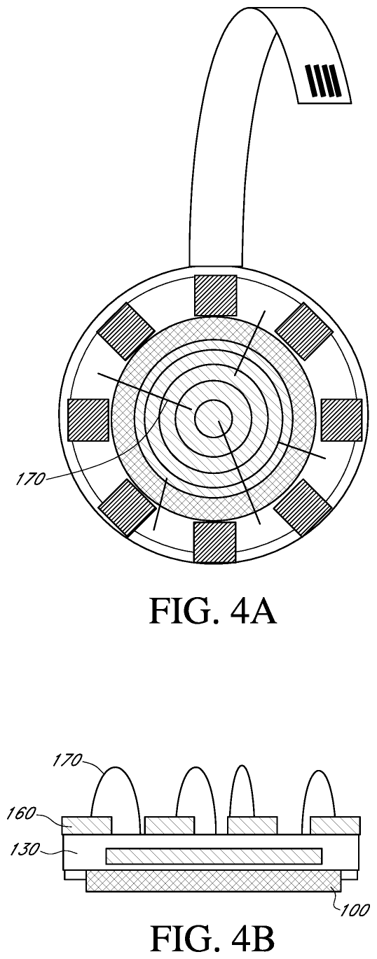

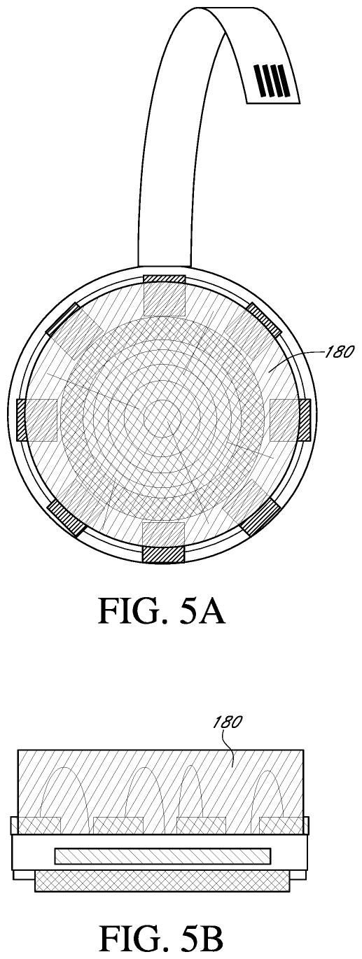

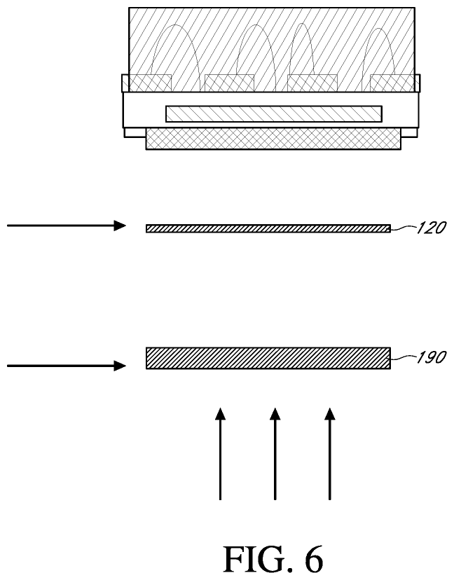

The spatial distribution of the contact pads 160 around the peripheral region of the ultrasound transducer facilitates electrically connecting (e.g., wire bonding or conductive epoxying) of the contact pads 160 to the annular array elements 115. This is shown in FIGS. 4A and 4B, where electrical connections 170 (e.g., wire bonds 170 or conductive epoxy 170) are shown between the contact pads 160 and the annular electrodes 115 of the ultrasound transducer. It is noted that FIG. 4B is a cross-sectional profile that omits the elongate segment of the flexible printed circuit board. FIGS. 5A and 5B show how a backing material 180 may be added to contact the first surface of the ultrasound transducer and encapsulate the electrical connections (e.g., wire bonds or conductive epoxy). FIG. 6 shows the addition of the ground electrode 120 to the second side of the piezoelectric layer, and the addition of a matching layer 190.

In embodiments in which the annular support ring is electrically conductive, a spatial gap (not shown in FIG. 2A) is maintained between the inner portion of the peripheral support ring 130 and the outer portion of the ultrasound transducer 100. Furthermore, although the piezoelectric layer 105 is shown having a disc shape, it will be understood that other shapes (e.g. square or rectangular may be employed). However, it will be beneficial to employ a circular shape in order to reduce the cross-sectional size (e.g. diameter) of the overall device.

In the example embodiment illustrated in FIGS. 2A to 7, the elongate flexible segment 145 of the flexible printed circuit board 140 is connected to the distribution segment 150 such that the elongate flexible segment extends outwardly from the peripheral support ring. However, in other example embodiments that are described here below, the elongate flexible segment 145 may be connected to the distribution segment 150 such that a distal portion of the elongate flexible segment 145 is encapsulated within the backing material, and such that the distal portion of the elongate flexible segment 145 extends inwardly (e.g., parallel and along the transducer surface) from the peripheral support ring 130 and bends outwardly (e.g., perpendicular to the transducer surface) away from the first surface 110 of the ultrasound transducer, within the backing material. In one embodiment, the elongate flexible segment 145 may be connected to the distribution segment 150 such that a distal portion of the elongate flexible segment 145 is encapsulated within the backing material, and such that the distal portion of the elongate flexible segment 145 extends parallel and along the transducer surface from the peripheral support ring 130 and bends perpendicular to the transducer surface away from the first surface 110 of the ultrasound transducer, within the backing material.

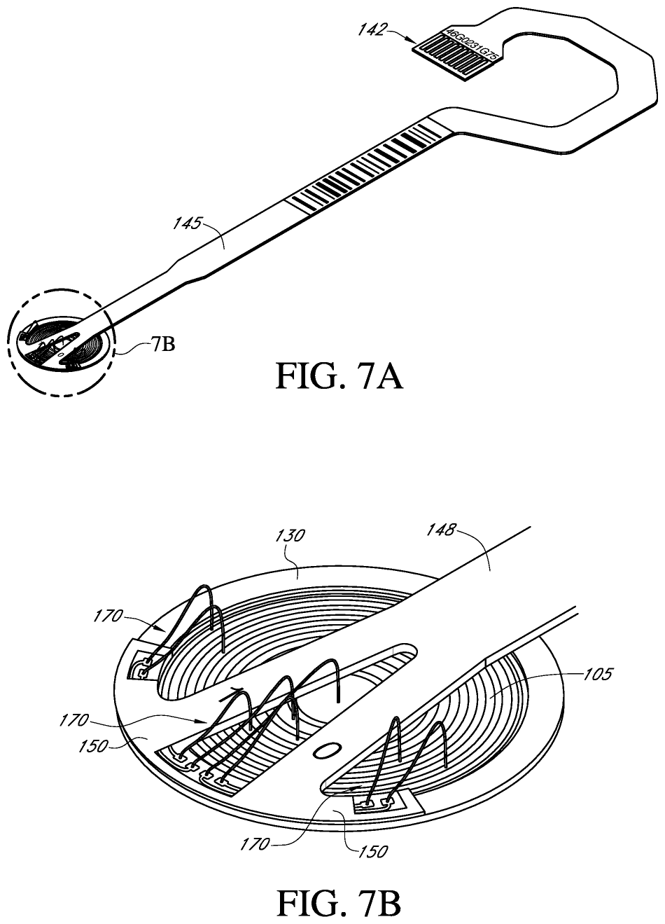

An example of such an embodiment is illustrated in FIGS. 7A and 7B, where FIG. 7A shows the device including the full length of the flexible printed circuit board 140, while FIG. 7B shows a detail (A) illustrating how the distal portion 148 of the elongate flexible segment 140 is connected to the distribution segment 150. As shown in FIG. 7B, the distal portion 148 of the elongate flexible segment 145 extends inwardly (e.g., parallel and along the transducer surface) from the peripheral support ring 130. This distal portion 148 may be bent outwardly (e.g., perpendicular to the transducer surface) away from the first surface of the ultrasound transducer, such that the distal portion 148 of the elongate flexible segment avoids contact with the electrical connections 170 (e.g., wire bonds 170 or conductive epoxy 170)and does not contact the first surface 110 of the ultrasound transducer.

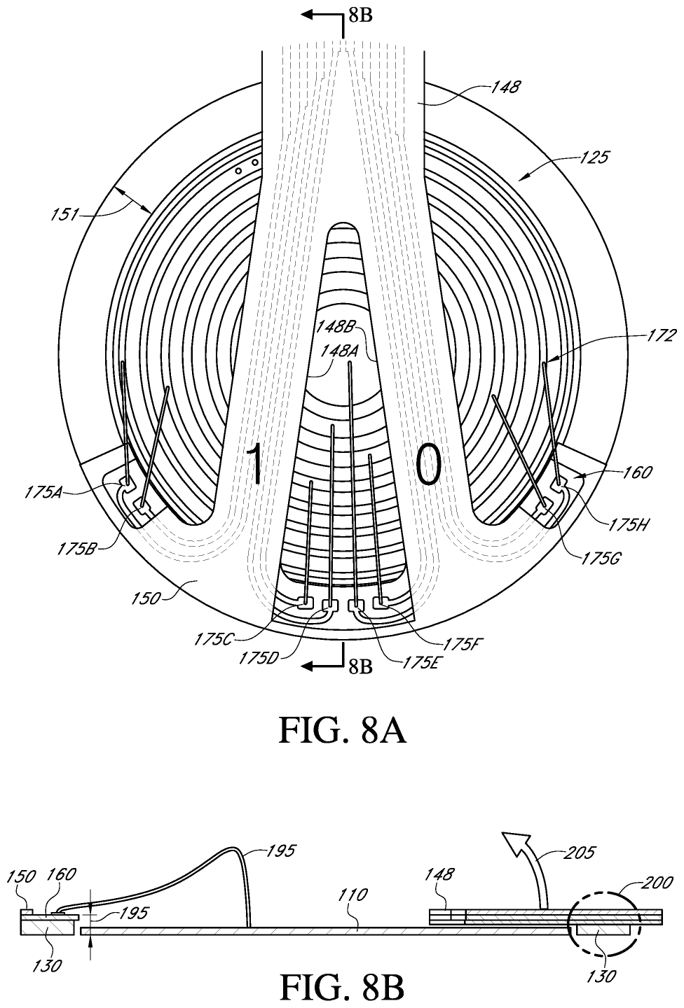

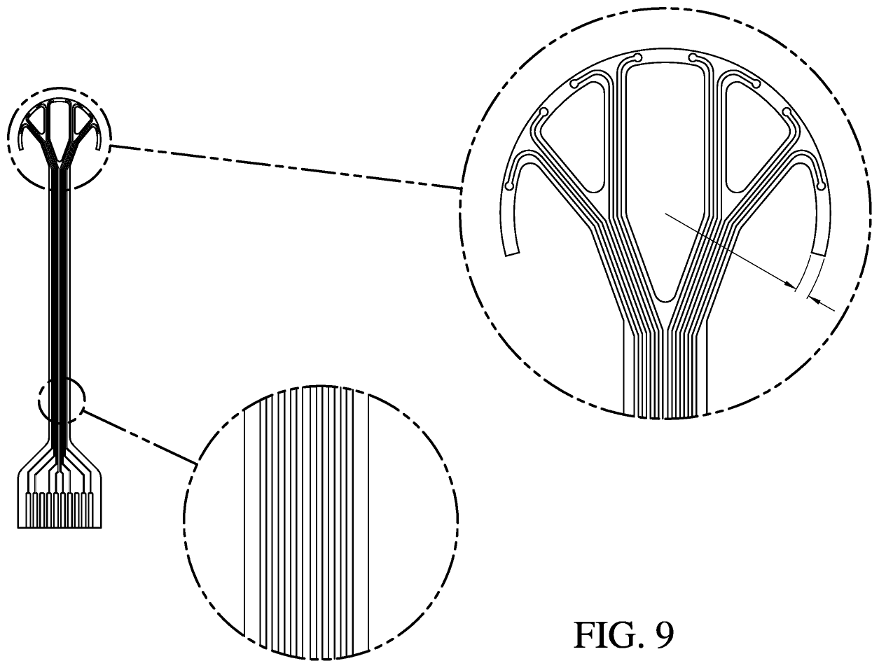

Referring now to FIG. 8A, an overhead view is provided that shows the configuration of the distal portion of the elongate flexible segment 148 relative to the peripheral support ring 130. The figure also illustrates the routing of the various conductive paths of the flexible printed circuit board to different contact pads 160 within the distribution segment 150 of the flexible printed circuit board. The figure shows the electrical connections (e.g., wire bonds or conductive epoxy)that extend from each contact pad (175A-H) to respective annular electrodes (e.g. see 172). In the present example embodiment, the peripheral support ring 130 is electrically conductive, and a gap 125 is provided between the outer perimeter of the ultrasound transducer and the inner edge of the peripheral support ring 125 to electrically isolate the peripheral support ring 130 from the annular electrodes 115 (note however that electrical contact is made between the peripheral support ring 130 and the ground plane electrode that is formed on the second side of the ultrasound transducer after infiltration with the backing material).

As shown in FIG. 8A, the conductive paths of the flexible printed circuit board may be routed bi-directionally within the distribution segment 150, such that some of the conductive paths are routed within the distribution segment 150 in one peripheral direction, while other conductive paths are routed in the distribution segment 150 in an opposing peripheral direction. For example, an even number of conductive paths may be routed in each direction. Such embodiments may be beneficial in reducing or minimizing the transverse width 151 of the peripheral support ring 130 (measured in a direction perpendicular to the peripheral direction), since the minimum transverse width 151 is proportional or otherwise related to the number of conductive paths that are routed in a given direction. For example, the peripheral support ring may have a transverse width of less than 2 mm, less than 1 mm, less than 750 microns, or less than 500 microns. In some example implementations in which the peripheral support ring is an annulus, an outer diameter of the annulus may be selected to be 20 mm, less than 10 mm, less than 7 mm, or less than 5 mm.

In some embodiments, the distal portion 148 of the elongate segment of the flexible printed circuit may be a single segment. However, in other embodiments, such as the embodiment shown in FIG. 8A, the distal portion 148 may be split to provide a plurality of branched distal segments (e.g. branched distal segments 148A and 148B) that contact the peripheral support ring at different locations. The gap that is formed between the branched distal segments 148A and 148B may be employed for electrically connecting (e.g., wire bonding or conductive epoxying)at least a portion of the annular electrodes.

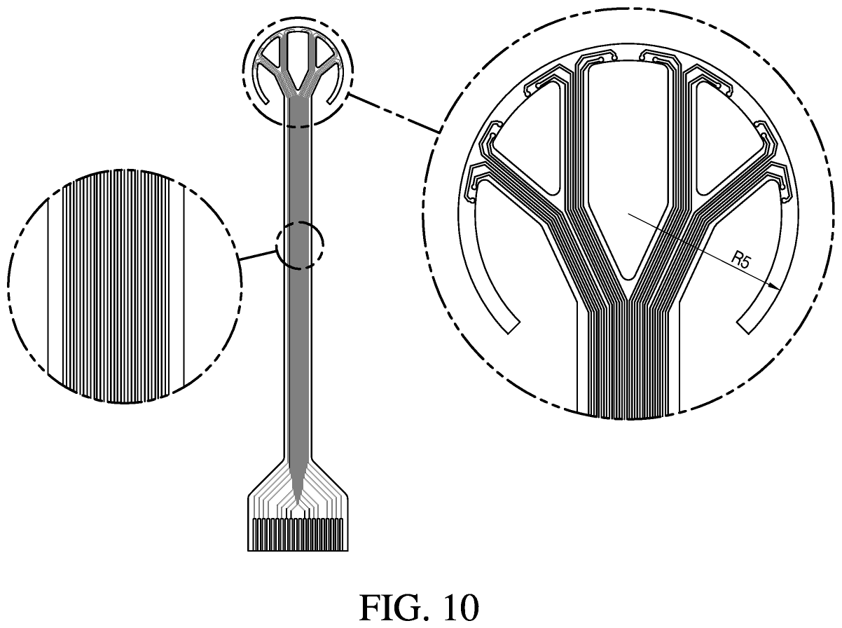

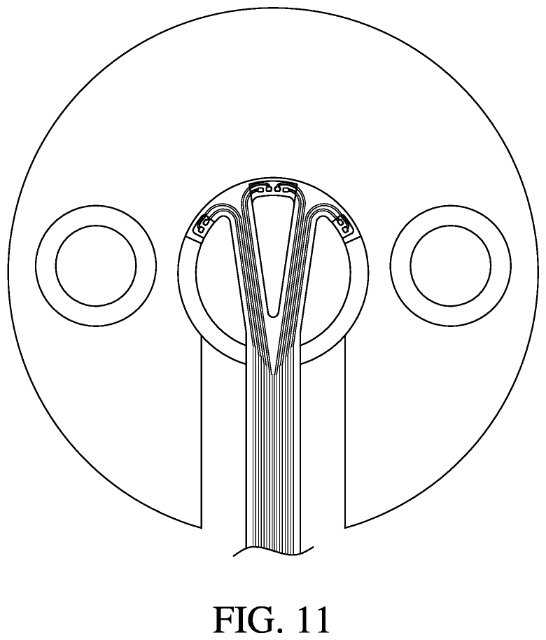

In one example implementation, the number of branched distal segments may be selected so that at least one branched distal segment includes only two conductive paths (optionally plus a ground path formed on a separate layer), such that when the two conductive paths are bi-directionally routed within the distribution segment, only one conductive path is routed in each direction. Such an example embodiment may be beneficial in enabling a thin peripheral support ring. An example of such an embodiment is shown in FIG. 9. FIG. 10 illustrates another example implementation in which sixteen conductive channels are split among four branched distal segments.

FIG. 8B shows a cross-sectional view of the embodiment shown in FIG. 8A, where the cross-section is taken through one of the electrical connections (e.g., wire bonds or conductive epoxy). As can be seen in the figure, the distal portion 148 of the elongate flexible segment may initially lay in contact with the peripheral support ring 130 in the region shown at 200. However, during assembly, the distal portion 148 is bent away (see arrow 205) from the surface 110 of the ultrasound transducer, thereby allowing the backing material to infiltrate the region below the distal portion 148, contacting the surface 110. In one embodiment, the orientation of the distal portion 148 allows the bend radius of the flex PCB to be larger than the full of the transducer 130 when exiting in a direction perpendicular to the surface 110. In an embodiment, this reduces stress on the flex PCB, increasing reliability and simplifying the fabrication process. In an embodiment, this allows for the flex to be directed backwards perpendicular to the transducer surface while maintaining a large flex bend radius. Several example manufacturing and assembly steps are described in further detail below. A spatial offset 195 may be provided between the upper surface of the peripheral support ring 130 and the first surface 110 of the ultrasound transducer (e.g. to assist with the infiltration of the backing material beneath the distal portion 148 near the distribution segment 150). Alternatively, the thickness of the peripheral support ring may be approximately equal to that of the ultrasound transducer.

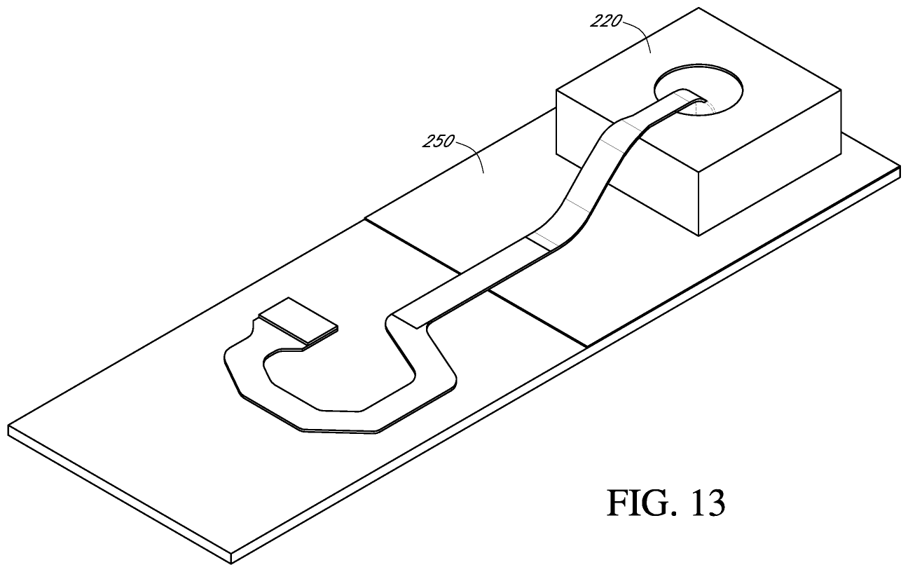

FIGS. 11-15 illustrate various steps in an example process of providing a backing material that encapsulates the distal portion of the elongate flexible segment of the flexible printed circuit board. According to the present example method, the distribution segment of the flexible printed circuit board is initially attached to the peripheral support ring. For example, the distribution segment may be soldered to the peripheral support ring if the peripheral support ring is formed from a metal (e.g. copper). This step may be achieved, for example, using a mounting jig, such as the example mounting jig shown in FIG. 13.

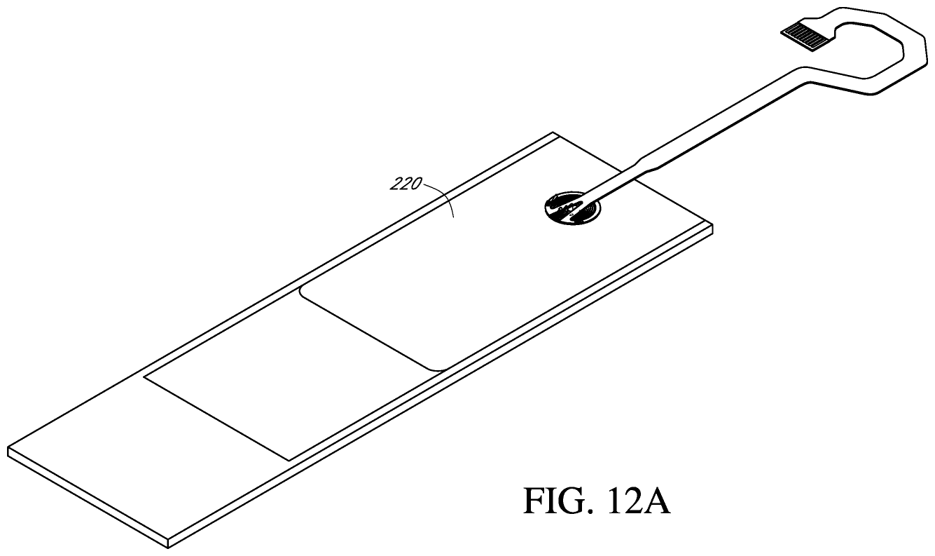

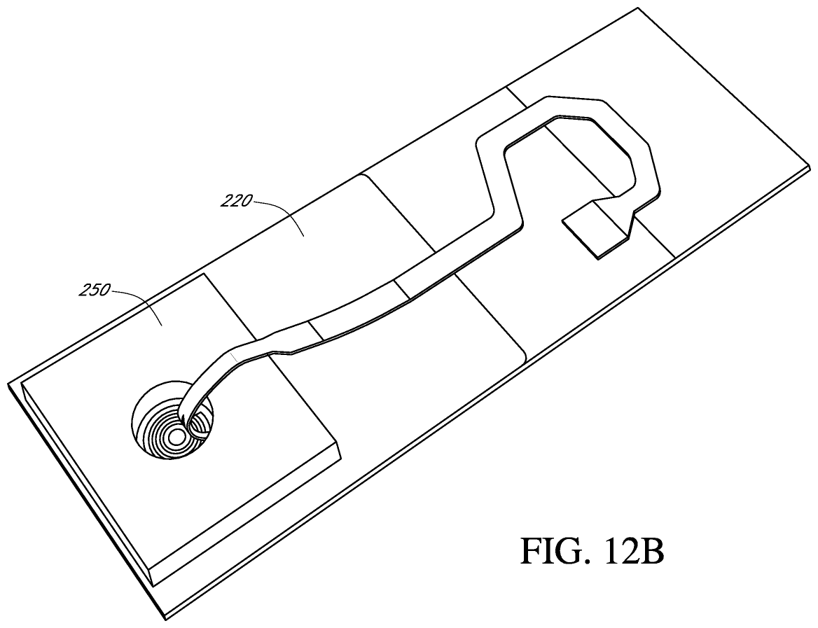

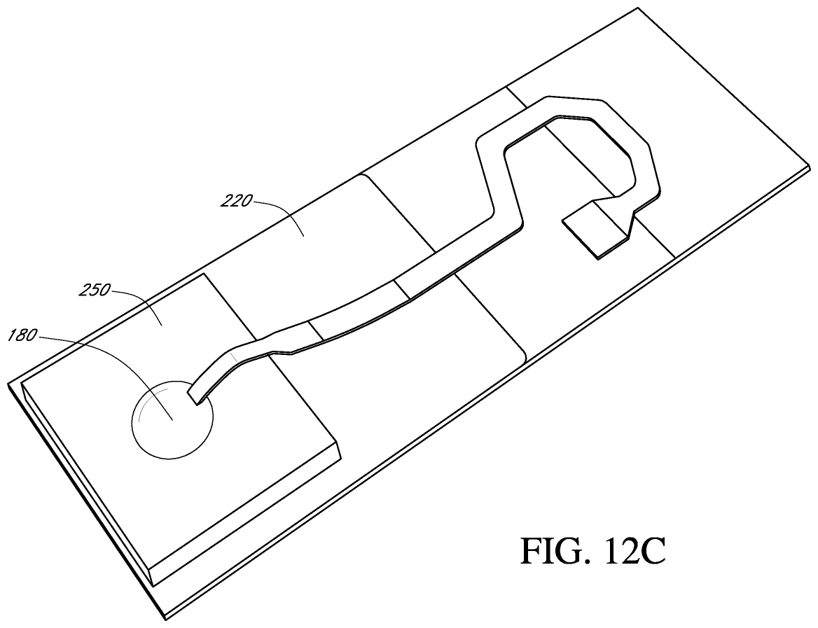

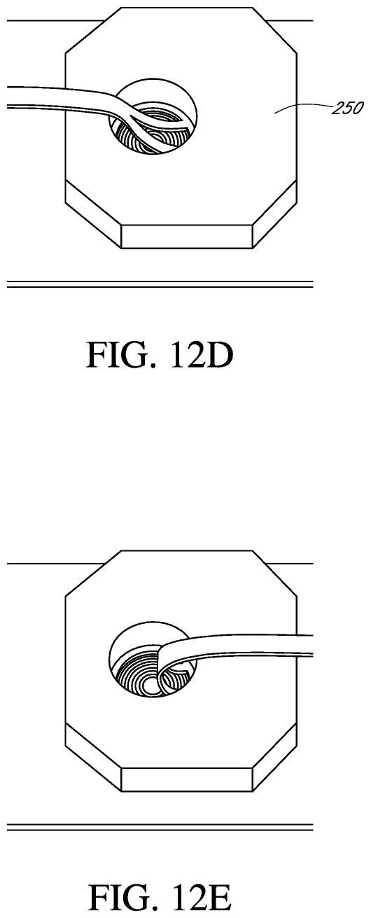

Having attached the flexible printed circuit board to the peripheral support ring, the peripheral support ring positioned to surround (at least in part) the ultrasound transducer. For example, as shown in FIG. 12A, the ultrasound transducer may be placed on double-sided tape 220, and the peripheral support ring may be placed on the double-sided tape so as to surround the ultrasound transducer. Electrically connecting (e.g., wire bonding or conductive epoxying)may then be performed.

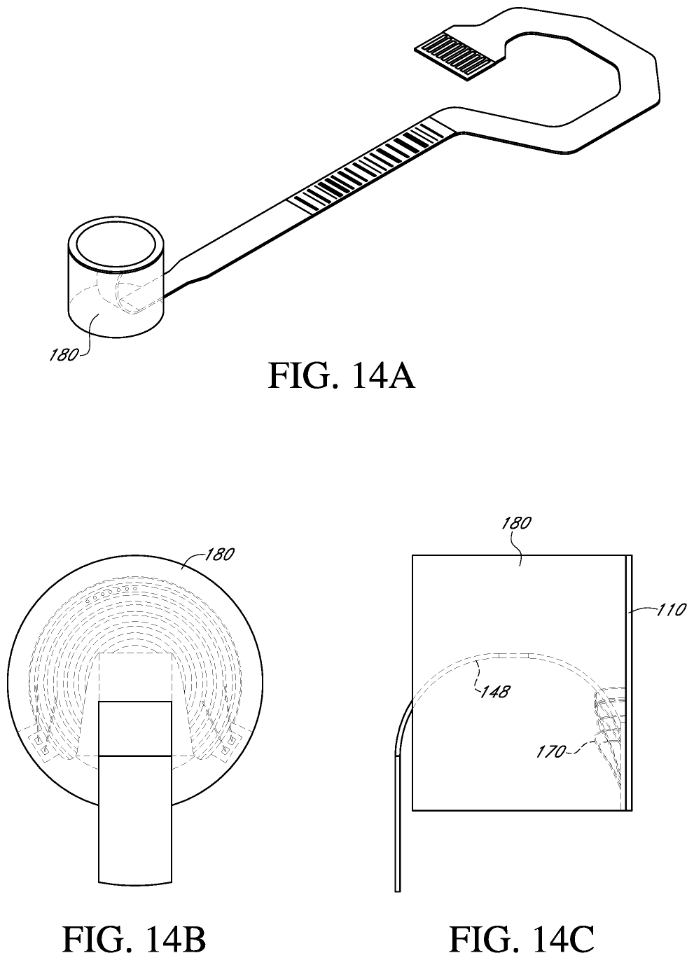

As shown in FIGS. 12B, 12C and 13, a removable mold 250, such as a silicone mold, may then be placed over the assembly. The mold 250 may be filled with a backing material (e.g., an acoustic backing material), such as an epoxy backing. It will be understood that a wide variety of backing materials may be employed. In some embodiments, the backing material is an acoustic backing material. The mold 250 may then be removed to yield an assembled device. As shown in FIGS. 14A-C, the backing material 180 is provided such that it contacts the first surface 110 of the ultrasound transducer, and the backing material 180 may fully encapsulate the electrical connections 170 (e.g., wire bonds 170 or conductive epoxy 170).

It will be understand that the use of a removable mold is merely illustrative of one non-limiting example assembly method. In another example method, a housing may be provided that forms an outer shell surrounding the backing material after the backing material is cured.

As shown in FIGS. 12D and 12E, the distal portion 148 of the elongate flexible segment may be bent in order to draw the distal portion away from the first surface of the ultrasound transducer, and to facilitate the infiltration of the backing material. For example, the distal portion of the elongate flexible segment may be bent such that the elongate flexible segment emerges through a distal surface of the backing material at an angle of approximately 90 degrees, less than 90 degrees, greater than or equal to 90 degrees, or between 90 and 180 degrees, relative to the first surface of the ultrasound transducer. The distal portion of the elongate flexible segment may be bent according to an initial radius of curvature that is less than 8 mm, less than 5 mm, less than 3 mm, or less than 2 mm.

As shown in FIGS. 14A-C, the distal portion of the elongate flexible segment may be encapsulated within the backing material such that it emerges from a distal surface of the backing material without extending beyond a side surface of the backing material. FIG. 14C shows a non-limiting example implementation in which the elongate flexible segment emerges from the backing material at an angle of approximately 180 degrees relative to the first surface of the ultrasound transducer.

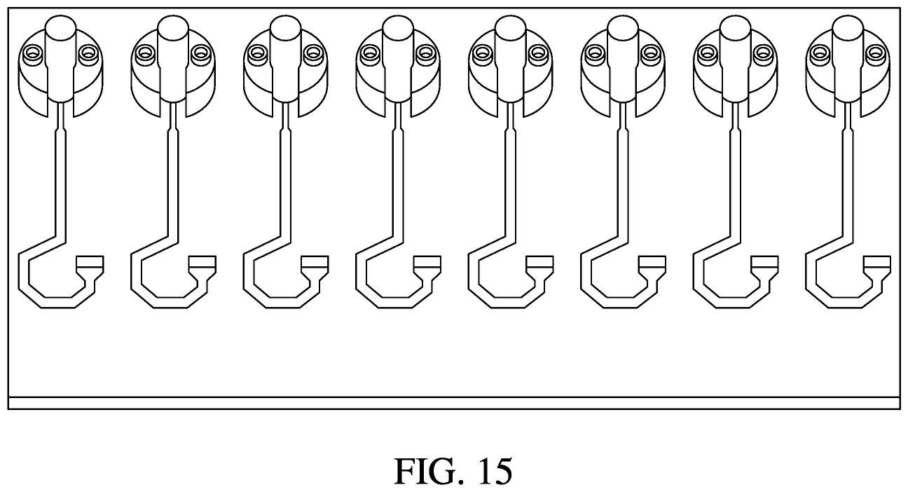

FIG. 15 shows eight assembly jigs as individually depicted in FIG. 11, each containing a peripheral support ring having a flexible printed circuit board mounted thereto for the purpose of reflow soldering.

Although many of the preceding embodiments employ a backing layer that encapsulates a portion of the elongate flexible segment of the flexible printed circuit board, other example embodiments may be realized using an air-backed configuration. For example, a housing, or guide piece may be attached to the peripheral support ring, where the housing or guide piece includes one or more features to bend and support the distal region of the elongate flexible portion.

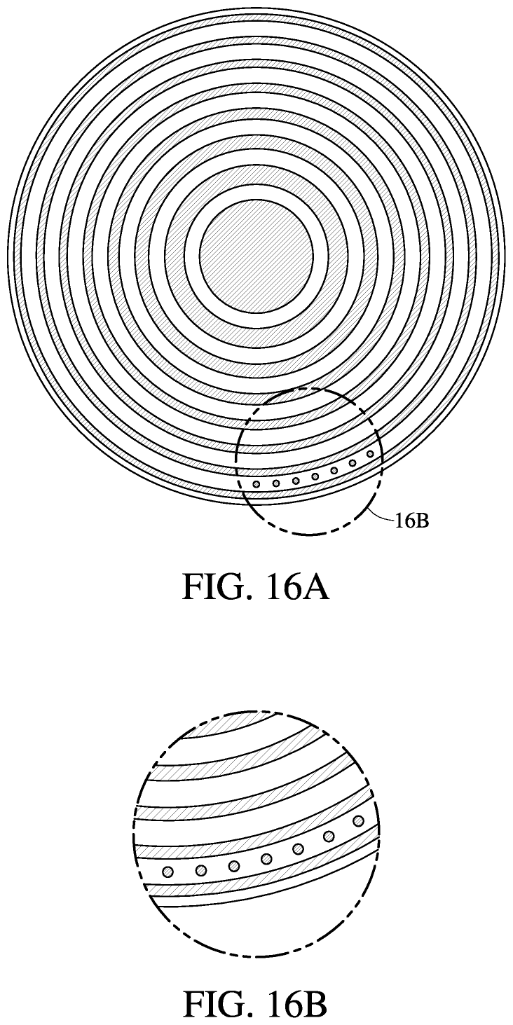

As shown in FIGS. 16A and 16B, one or more annular regions between the annular electrodes may be encoded with conductive markings such as text, barcodes, and other symbols. These conductive markings may be included in the mask that is employed to form the annular electrodes, and the markings may uniquely identify each annular array on a given wafer. In the example implementation shown in FIGS. 16A and 16B, the markings are a series of dots, where each dot encodes one bit of a seven-bit identifier, where a “one” is indicated by the presence of a conductive dot, and a “zero” is indicated by the absence of a conductive dot.

The example embodiments disclosed herein may be employed for the electrical connection and packaging of annular ultrasound transducers in which cost and size are reduced or minimized. In some implementations, size and/or cost reduction may be achieved through the use of a kerfless annular array, and/or the use of a sparse annular array. A sparse annular array is an annular array in which the annular electrodes are thin with relative large gaps separating them. For example, a sparse annular array may be defined as an annular array for which the annular electrodes cover less than half of the transducer surface within the region bounded by the outer annular ring. In one embodiment, this has the effect of reducing the variance in delay across each element for a given depth, thereby lowering the level of secondary lobes, which limit the dynamic range (contrast) in the image. In one embodiment, this has the effect of shortening the phase shift across each element for a given depth, thereby directly lowering the level of secondary lobes, which limit the dynamic range (contrast) in the image.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. An ultrasound device comprising:
an ultrasound transducer comprising an annular ultrasound array, wherein said annular ultrasound array comprises a plurality of concentric annular electrodes provided on a first surface of a piezoelectric layer, and wherein a ground plane electrode is provided on a second surface of said piezoelectric layer;
a peripheral support ring surrounding at least a portion of said ultrasound transducer;
a flexible printed circuit board comprising:
an elongate flexible segment; and
a distribution segment that is in contact with at least a portion of said peripheral support ring, such that a plurality of conductive paths extending through said elongate flexible segment are routed through said distribution segment to respective contact pads located at different locations on said peripheral support ring;
wherein each of the plurality of concentric annular electrodes is electrically connected to a respective contact pad;
wherein at least one of the plurality of conductive paths is a ground conductive path that is in electrical contact with said ground plane electrode, and
a backing material contacting and extending from said first surface, wherein a distal portion of said elongate flexible segment is encapsulated in said backing material, such that said distal portion of said elongate flexible segment extends from said peripheral support ring within said backing material, without contacting said first surface.

2. The ultrasound device according to claim 1 wherein said plurality of conductive paths are routed bi-directionally within said distribution segment.

3. The ultrasound device according to claim 1 wherein said distal portion of said elongate flexible segment is bent, within said backing material, over an angle ranging between 90 degrees and 180 degrees relative to said first surface.

4. The ultrasound device according to claim 1 wherein said distal portion of said elongate flexible segment comprises a plurality of branched distal segments that contact said peripheral support ring at different locations with gaps defined therebetween.

5. The ultrasound device according to claim 4 wherein one or more of said plurality of branched distal segments comprises two conductive paths, wherein said two conductive paths are bi-directionally routed to different contact pads.

6. The ultrasound device according to claim 4 wherein one or more wire bonds are formed within each gap.

7. An ultrasound device comprising:
an ultrasound transducer comprising an annular ultrasound array, wherein said annular ultrasound array comprises a plurality of concentric annular electrodes provided on a first surface of a piezoelectric layer, and wherein a ground plane electrode is provided on a second surface of said piezoelectric layer;
a peripheral support ring surrounding at least a portion of said ultrasound transducer;
a flexible printed circuit board comprising:
an elongate flexible segment; and
a distribution segment that is in contact with at least a portion of said peripheral support ring, such that a plurality of conductive paths extending through said elongate flexible segment are routed through said distribution segment to respective contact pads located at different locations on said peripheral support ring;
wherein each of the plurality of concentric annular electrodes is electrically connected to a respective contact pad;
wherein at least one of the plurality of conductive paths is a ground conductive path, and
a backing material contacting and extending from said first surface, wherein a distal portion of said elongate flexible segment is encapsulated in said backing material, such that said distal portion of said elongate flexible segment extends outwardly away from said first surface without contacting said first surface.

8. The ultrasound device according to claim 7 wherein said elongate flexible segment is encapsulated within said backing material and emerges from a distal surface of said backing material without extending beyond a side surface of said backing material, wherein said elongate flexible segment emerges from said backing material at an angle of greater than or equal to 90 degrees relative to said first surface.

9. The ultrasound device according to claim 7 wherein an initial radius of curvature of said distal portion of said elongate flexible segment is less than 8 mm.

10. The ultrasound device according to claim 7 wherein a contact surface of said peripheral support ring that contacts said distribution segment is spatially offset from said first surface.

11. The ultrasound device according to claim 7 wherein said elongate flexible segment extends outwardly from said peripheral support ring.

12. The ultrasound device according to claim 7 wherein said ultrasound transducer is disc shaped, and wherein said peripheral support ring is at least a portion of an annulus, wherein an outer diameter of said annulus is less than 10 mm.

13. The ultrasound device according to claim 7 and wherein said peripheral support ring is in electrical communication with said ground conductive path and said ground plane electrode.

14. An ultrasound device comprising:
an ultrasound transducer comprising an annular ultrasound array, wherein said annular ultrasound array comprises a plurality of concentric annular electrodes provided on a first surface of a piezoelectric layer, and wherein a ground plane electrode is provided on a second surface of said piezoelectric layer;
a peripheral support ring surrounding at least a portion of said ultrasound transducer;
a flexible printed circuit board comprising:
an elongate flexible segment; and
a distribution segment that is in contact with at least a portion of said peripheral support ring, such that a plurality of conductive paths extending through said elongate flexible segment are routed through said distribution segment to respective contact pads located at different locations on said peripheral support ring;
wherein each of the plurality of concentric annular electrodes is electrically connected to a respective contact pad; and
a backing material contacting and extending from said first surface, wherein a distal portion of said elongate flexible segment is encapsulated in said backing material, such that said distal portion of said elongate flexible segment extends from said peripheral support ring and bends away from said first surface.

15. The ultrasound device according to claim 14 wherein said plurality of conductive paths are routed bi-directionally within said distribution segment.

16. The ultrasound device according to claim 14 wherein said peripheral support ring has a transverse width of less than 1 mm.

17. The ultrasound device according to claim 14 wherein said peripheral support ring completely surrounds said ultrasound transducer.

18. The ultrasound device according to claim 14 wherein said ultrasound transducer is disc shaped, and wherein said peripheral support ring is at least a portion of an annulus, wherein an outer diameter of said annulus is less than 10 mm.

19. The ultrasound device according to claim 14 and wherein said peripheral support ring is in electrical communication with said ground conductive path and said ground plane electrode.

20. The ultrasound device according to claim 14 wherein said plurality of concentric annular electrodes are provided in a sparse configuration, thereby defining a sparse annular ultrasound array.
